(19) United States
(12) Patent Application Publication
(10) Pub. No.: US 2003/0093379 A1
(43) Pub. Date: May 15, 2003

(54) Automated transaction machine

(76) Inventor: Yumi Hatanaka, Owariasahi (JP)

Correspondence Address: MCDERMOTT, WILL & EMERY, 600 13th Street, N.W., Washington, DC, 20005-3096, US

(21) Appl. No.: 10/280,129

(22) Filed: Oct. 25, 2002

(30) Foreign Application Priority Data
Oct. 30, 2001 (JP) 2001-331801

(51) Int. Cl. G06F 17/60

(52) U.S. Cl. 705/43

(57) ABSTRACT

The present invention enhances the convenience of cards, especially the type of cards with IC chips and a plural of magnetic strips thereon, in an automated transaction machines (ATMs). The ATMs display a correct insertion of a card or a bankbook with a series of serial images when the inserted status of the card or the bankbook is incorrect for the transaction, such as the insertion in the opposite direction. As possible applications for the series of serial images, there are images in moving picture and a series of static images. Guidance with the series of serial images enables customers to easily understand the operations as to how to change the direction of the card or the bankbook, and how to flip the page of the bankbook.

### BACKGROUND OF THE INVENTION

1. Field of the Invention

The present invention relates to an automated transaction machine that performs transactions with cards and bankbooks. In diverse credit institutions, customers frequently use automated transaction machines (hereafter referred to as “ATMs”) for deposits and withdrawals. Various types of cards, such as a credit card, a debit card and a cash-card, are available for the transactions with ATMs. These cards and bankbooks (possibly referred to as “media”) have magnetic strips thereon that records information regarding a bank account number and a personal identification numbers (hereafter referred to as “PIN”). Some cards have more than two magnetic strips along, for example, both the upper edge and the lower edge thereof (hereafter refer this type of card to as “multi-stripe card”).

Recently, a contact IC chip or a non-contact IC chip has been widely used for the cards as well as magnetic strips (hereafter refer this type of cards to as “IC card”). In some cases, both a contact and a non-contact IC chips are mounted on one card. Comparing with magnetic strips, these IC chips are capable of storing much more information in small area, so that an IC card functions to integrate more accounts and more transactions than multi-stripe card. There is also an advantage of high security as it is difficult to alter the information stored in IC chips illegally.

As to well known in the art, JP10-105782A discloses ATMs including displays that direct the insertion of the cards.

### SUMMARY OF THE INVENTION

The diverse types of cards cause incorrect insertions of the card to ATM, thereby making some troubles in transactions.

FIG. 1 illustrates a multi-strip IC card 10. The card 10 has two magnetic strips 11 and 12 along both upper and lower edges thereof respectively as well as a contact IC chip 13 and a non-contact IC chip 14. The card 10 should be inserted in the proper direction for using the magnetic strip 11, as shown at the middle of FIG. 1, which schematically illustrates a cross-sectional view of a card handler 20. The card 10, which is inserted from a card input slot 23 in the proper direction, is transported to a position A. A head 21 reads out information recorded in the magnetic strip 11 through the transportation. Thereafter, the card 10 is transported to a position B and a head 22 reads out information stored in the IC chip 13 during then. With the insertion of the card 10 in the proper direction, the information recorded in the IC chip 13 thus can be read out without the need for reinsertion.

On the other hand, the card 10 should be inserted in the reverse direction for using the magnetic strip 12, as shown at the bottom of FIG. 1. With the insertion of the card 10 in the reverse direction, the head 21 reads out the information recorded in the magnetic strip 12 on its way to the position A similar to the insertion in the proper direction. The head 22 is, however, unable to read out the information stored in the IC chip 13 during the transporting to the position B.

Accordingly, a customer is required to turn over the card direction corresponding to a transaction. For example, the proper direction is required for using the magnetic strip 11 and the IC chips, and is required the reverse direction for using the magnetic strip 12. If the customer incorrectly inserts the card, he or she has to reinsert it as appropriate information cannot be read out.

As the ATMs are widely used by general public, from young people to old people, which are usually operated in unattended status, some customers are unable to understand required handling for the reinsertion of the card and have to cancel the transaction.

Similarly, some customers have troubles when inserting bankbooks in a wrong direction or with a wrong page opened. The present invention thus addresses or solves the above inconvenience of the operation with ATMs, and provides easier operations to customers so as to deal with the incorrect status of the card or the bankbook.

To attain at least part of the above and the other related objects in the present invention, the present invention directs an correct insertion with a series of serial images, including a moving picture or a combination of a plurality of static images when the card or the bankbook is inserted incorrectly for the required transaction with ATMs. The series of serial images helps customers to understand easily how to turn over the card or the bankbook, or how to change the page of the bankbook.

In the present invention, it is preferable that the series of serial images includes a sequential images, from the incorrect insertion to the correct insertion. By starting at the incorrect insertion, that is, the current condition, it can present easier guidance for customers to be understood.

The series of serial images may also include guidance for changing the inserted direction of the card or the bankbook. There are two possible cases of changing the inserted direction with regard to the card. One case is in the proper or the reverse direction and another is in the top side and the back side. The guidance with the series of serial images can clearly direct which case is required to customers. The invention is not restricted to guidance on ATMs described above, but may also be actualized by a diversity of the applications, for example, guidance to turn over the page of the bankbook at the insertion, guidance to have the card with the non-contact IC chip approach to an IC chip reader, and guidance to present a bar code or a emboss, with information optically stored thereon, to a reader.

In the present invention, the series of serial images is not restricted to a sequence of images in even speed or size, but may be displayed at a slow speed, that is, in slow motion, or zoomed at the important part. The guidance with an audio assist, text and static images may be used together with the series of serial images at the same time, before and after the series of serial images.

The invention is not restricted to the transactions with cash, but may also be applicable to other transactions, such as the funds transfer from a certain account to another, the pay by debit card and the credentialing by public institutions. According to one embodiment of this invention, ATMs are preferably configured as ATMs or cash dispensers installed in credit institutions that enables deposits and withdraws of cash. Alternatively, another embodiment may also be applicable as a network system with a host computer and client computers. In that system, the client computers may correspond to ATMs in the present invention. Each client computer has a reader that reads out information magnetically recorded in the card and the bankbook, and thereby enables a transaction by sending the information to the host computer via a network. Guidance is presented, for example, by displaying the series of serial images onto a display of the client computer when the incorrect status of the card and the banknote is detected. The guidance data may be installed in the client computers in advance, or alternately may be downloaded from the host computer in each case.

Furthermore, there are a diversity of other applications of the present invention, such as guidance method that presents guidance in the above ATMs, a computer program attaining such a method and a recording medium in which such a computer program is recorded. Various media is available as the recording medium, such as flexible disks, CD-ROMs, DVDs, the magnet-optical disks, IC cards, ROM cartridges, the punched cards, the printed matters on which signs like bar codes are printed and the internal and external storage like RAM and ROM, that are readable optically, magnetically and electronically by a computer.

### BRIEF DESCRIPTION OF THE DRAWINGS

FIG. 1 illustrates a multi-strip a card 10;

FIG. 2 schematically illustrates the structure of an automated transaction system (hereafter referred to as “ATM”) in an embodiment of the present invention;

FIG. 3 is a flow chart of deposit and withdrawal transaction;

FIG. 4 schematically illustrates a guidance displayed on a guidance frame;

FIG. 5 schematically illustrates a series of serial images;

FIG. 6 schematically illustrates a series of serial images where a bankbook is reinserted; and

FIG. 7 schematically illustrates the structure of ATM 300 in a modification of the present invention.

### DESCRIPTION OF THE PREFERRED EMBODIMENT

One mode of performing the present invention is discussed below as one embodiment.

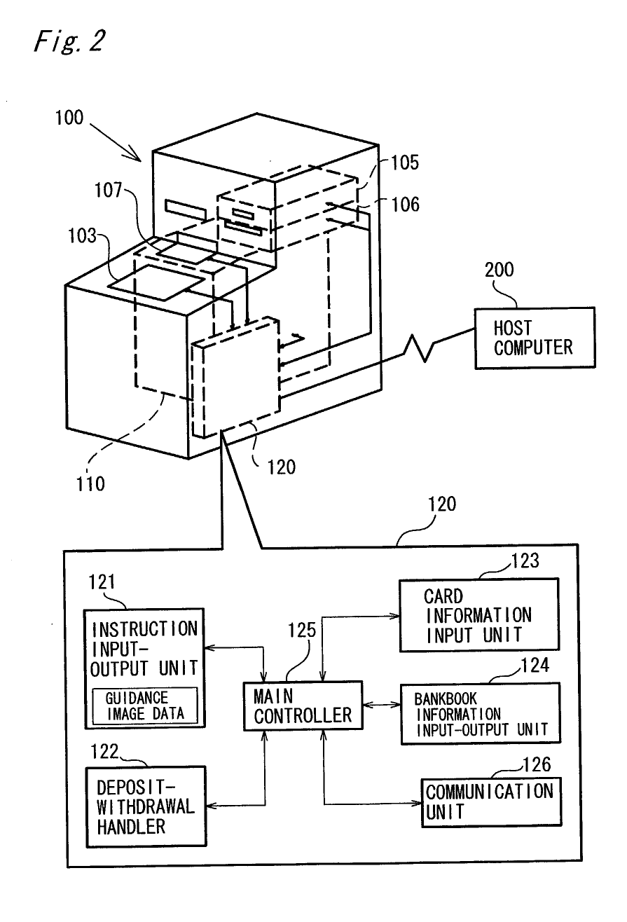

FIG. 2 schematically illustrates a structure of an ATM and an automated transaction system as an embodiment of the present invention. The ATM, which is installed in banks and other credit institutions, deals with transactions, such as deposits and withdrawals without an attendant. Those transactions with the ATM include deposits and withdrawals to and from customers' accounts, and loan. The following embodiment describes the ATM with an example of deposits and withdrawals of cash, however, there are a diversity of applications other than dealing with cash, such as credentialing by public institutions.

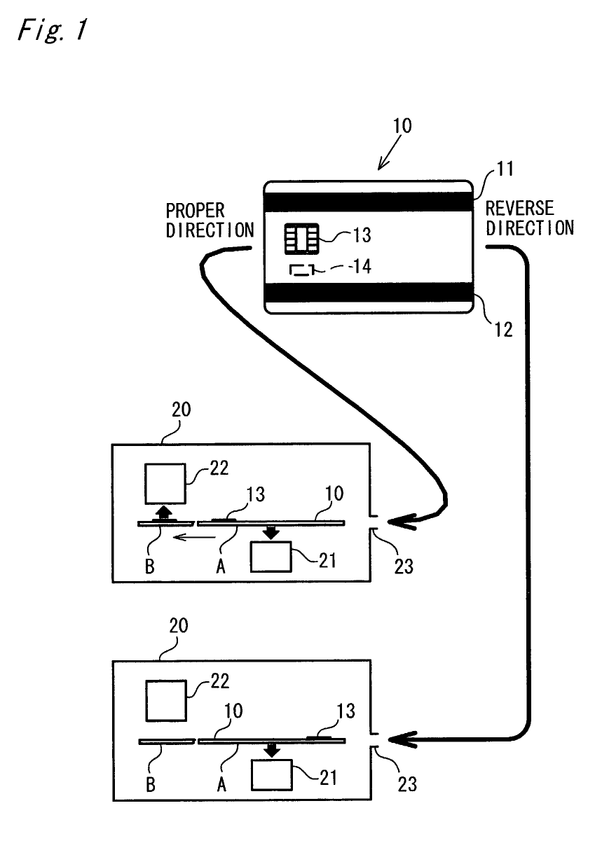

An ATM 100 in this embodiment is applicable to a card with IC chips thereon as well as a card with a single or more than two magnetic strips thereon. The card 10 is schematically illustrated in FIG. 1. Both contact and non-contact IC chips are available.

The ATM 100 of the present invention has a plurality of units in the arrangement illustrated in FIG. 2. A card handler 105 reads out information recorded in magnetic strips and IC chips, similar to the card handler 20 in FIG. 1. The information, recorded in a card, includes a bank account number and a PIN that identify a card holder or a customer. Each magnetic strip records the information to identify the corresponding account thereon, and the IC chip records the information of multiple accounts. Each magnetic strip also records the information to identify the type of card thereon that indicates whether or not IC chips are attached, and specifies the inserted direction of the multi-strip card.

A bankbook handler 106 reads out information recorded in a magnetic strip on a bankbook, and recording the result from a transaction. A bankbook is used corresponding to the type of transaction. In the present invention, a bankbook, which can be used for more than two deposits, for example, an ordinary deposit and a fixed deposit, may be applicable by starting the record from the opposite side each other. Similar to a multi-strip card, a customer inserts the bankbook in the proper direction for the ordinary deposit, and in the reverse direction for the fixed deposit. The front cover and the back cover of the bankbook respectively have magnetic strips thereon including the identification information, and thereby enabling the inserted status to be specified. Hereafter, this type of bankbook is expediently referred to as “multi-strip”. In addition, the card handler and the bankbook handler may be simply referred to as “a media handler” or “a media handling unit” by connecting together.

An operation unit 103 is a user interface to display and input information required for deposit and withdrawal transactions. In this embodiment, a touch panel is applied however, the operation panel may be a combination of a display with push button switches. The operation unit 103 also displays guidance as to how to operate the ATM and how to insert the card and the bankbook.

The ATM accepts and dispenses bills from and to the customer via a cash delivery slot 107. When it accepts cash, a build-in cash-handling device 110, included in the ATM, discriminates the bills and separately stores the discriminated bills therein corresponding to their denomination values. When required to withdraw the bill, a cash-handling device 110 processes the required amount of bills, and delivers cash to the customer.

The ATM 100 is not restricted to the above configuration shown in this embodiment, but may be included a diversity of other units and mechanisms. For example, the ATM may have a bankbook statement bolder and an audio assist.

A controller 120 controls the operations of the respective constituents included in the ATM 100. The controller 120 is a microcomputer that includes a CPU and memories. The controller 120 exchanges information with respective constituents, as shown in FIG. 2, so as to control the whole operations in the ATM 100. The ATM 100 is connected to a host computer 200 in credit institutions via a network. A controller 120 communicates with the host computer 200 accordingly, and performs processing deposit and withdrawal transactions.

FIG. 2 shows functional blocks of the controller 120 with regard to deposit and withdrawal transactions. In this embodiment, each functional block is implemented by software and controlled by a main controller 125, however, it may be also implemented by hardware.

A card information input unit 123 controls the card handler 105, and inputs the information recorded in magnetic strips and IC chips. A input-output unit bankbook information input-output unit 124 controls a bankbook handler 106 so as to input information recorded in the bankbook, and records results of transactions in the bankbook. A deposit-withdrawal handler 122, which controls whole processing relating to the deposit and the withdraw through the main controller 125, receives the information recorded in a card or a bankbook.

An instruction input-output unit 121 controls the operation unit 103 so as to display windows, such as an operation menu for a customer, and inputs the customer's instruction. The instruction input-output unit 121 also functions to display a guidance window regarding the operations for the ATMs, for example, guidance to insert a card or a bankbook, using the series of serial images. The series of serial images may be replayed in the moving picture, such as MPEG file and AVI file or alternatively in a sequence of static images. The guidance image data may be installed in the instruction input-output unit 121 in advance.

The deposit-withdrawal handler 122 receives the information, which is input from the instruction input-output unit 121, via the main controller 125. The deposit-withdrawal handler 122 accordingly forwards the information to the host computer 200 via a communication unit 126, so as to perform deposit and withdrawal transaction. When dealing with cash, the deposit-withdrawal handler 122 accepts or dispenses cash by controlling the bill handling device 110.

The transactions in the present invention are not restricted to the processing dealing with cash, but may also be applicable to transactions that transfer the information of the amount of money, such as the funds transfer from a certain account to another.

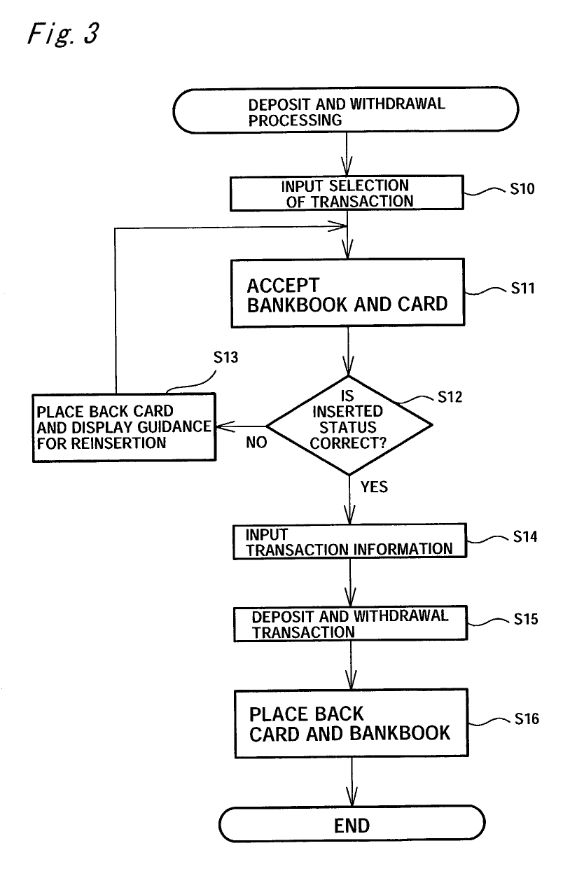

FIG. 3 is a flow chart of deposit and withdrawal processing that is performed by the controller 120. The controller 120 displays an initial menu onto the operation unit 103 and inputs the transaction item that is selected by a customer (Step S10). There are optional transaction items, such as deposit, withdrawal, funds transfer and loan, and further items may also be available for the transactions.

The controller 120 then accepts the insertion of the bankbook and the card (Step S11). The pattern of the media to be inserted in: whether only the bankbook should be inserted, only the card should be inserted or both the bankbook and the card should be inserted, is selected corresponding to the transaction. The controller 120 may display a guidance that directs the insertion of the card and the bankbook onto the operation unit 103. In the case of inserting both the card and the bankbook, there is no preference regarding the order.

When the card and the bankbook are inserted, the controller 120 judges whether or not the inserted status is correct, based on the identification information recorded in the magnetic strips thereon (Step S12). The inserted status should be judged as incorrect when the information, required for the selected transaction, is unable to be read out, as in the following cases.

In the first case, the information, recorded in magnetic strips, is unreadable, because of the insertion of the single-stripe card or bankbook in the opposite direction or side by mistake.

In the second case, the inserted status is incorrect to the selected transaction, such as the multi-strip card or bankbook being inserted in the reverse direction where the proper direction is required for the selected transaction or visa versa, IC card being inserted in the opposite direction and unreadable.

In the third case, there is no space left in the opened page of the bankbook when inserted.

Conditions to be judged as incorrect are not restricted to the above cases, but may include various options to be set.

The controller 120 includes a media insert judgment method. When the inserted status of the card and the bankbook has been judged as incorrect by this method, the controller 120 places back the inserted card and the bankbook, displays a guidance for reinsertion (Step S13) for reacceptance (Step 11). The guidance is discussed in detail later.

For explanatory, the judgment regarding the inserted status is performed for both the card and the bankbook after both are inserted in the flow chart of FIG. 3, however, it may also be applicable to repeat Steps S11 through S13 for any one of the card or the bankbook until inserted correctly, and then repeat those steps for another.

When the card and the bankbook thus are inserted correctly (Step S12), the controller 120 inputs the transaction information, such as the PIN and money amount (Step S14). When the IC card is inserted, the controller 120 also inputs the selection of the account depending on the transaction among several accounts stored in the IC chip. Then, the controller 120 performs deposit and withdrawal transactions, based on the obtained information (Step S15). The deposit and withdrawal transactions depends on the transaction items, includes communication with the host computer about the deposit and withdrawal information of the corresponding account, the issue of the bankbook statements, entering the records in the bankbook and dispensing/accepting cash. Upon completing the deposit and withdrawal transaction, the controller 120 places back the card and the bankbook (Step S16).

In the procedure of this embodiment, the transaction information is input after the inserted status has become correct, however, various patterns of orders may be applicable. For example, transaction information may be input without regard to the inserted status of the card and the bankbook (Step S14). Then the card and the bankbook may be placed back and reinserted if necessary, during or even after the input of the transaction information.

The guidance window for the reinsertion of the card and the bankbook (Step S13 in FIG. 3) is discussed in the following description.

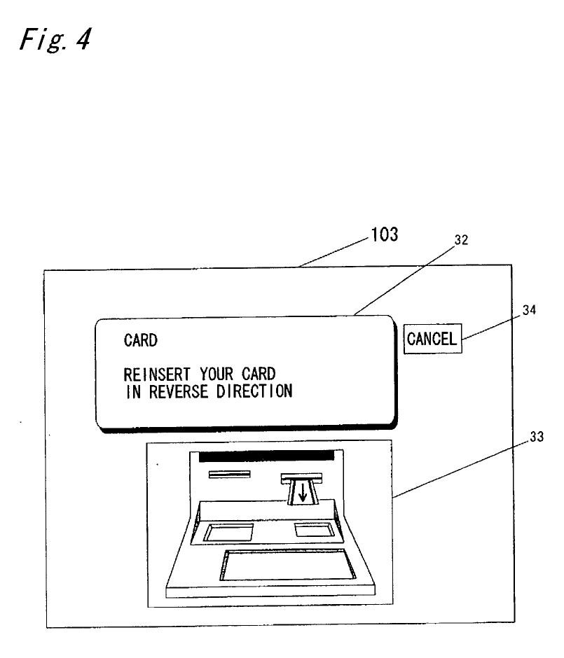

FIG. 4 schematically illustrates guidance displayed onto the guidance window of the example that directs the reinsertion of the card, inserted in the opposite direction. The guidance includes a text frame 32, a series of serial images 33 and a cancel button 34, which are displayed onto the operation unit 103. The cancel button 34 can be used for canceling the transaction without reinsertion of the card. Guide sentences explaining handlings for the card or the bankbook are indicated in the text frame 32. The series of serial images 33 displays the handlings in a series of serial images. An audio assist may be applicable instead of the guide sentences.

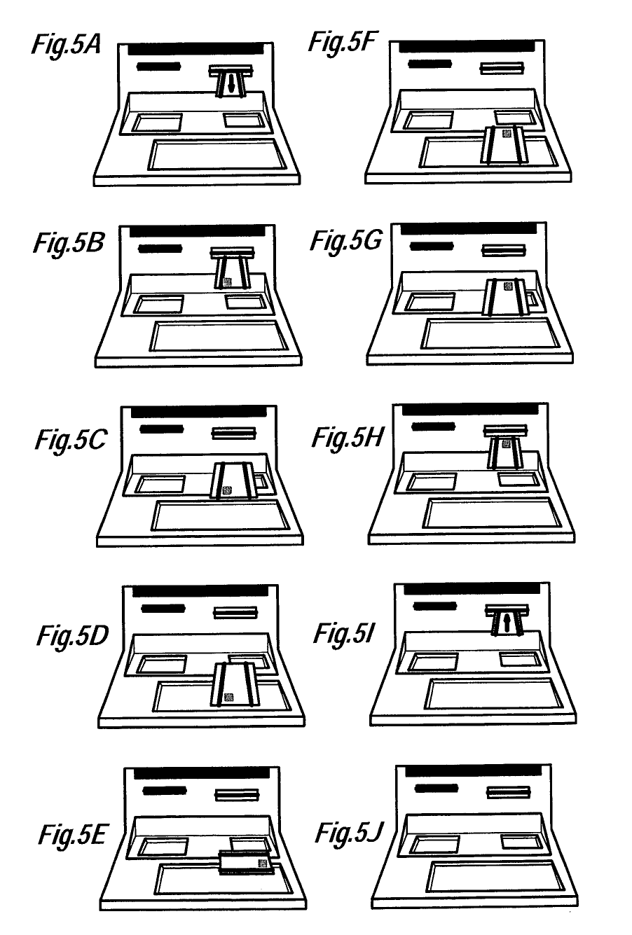

FIG. 5A through FIG. 5J schematically illustrate the series of serial images that is preferably displayed in conjunction with the text frame 32 in FIG. 4.

FIG. 5A through FIG. 5J can be displayed in order as the guidance. As shown in these figure, FIG. 5A-5Cshow dispense images indicating a card being dispensed from the card handler; FIGS. 5D-5F show changing images indicating a card being changed its direction in the cross direction and reinsertion image indicating a card being reinserted to the slot. As described above, these images may be displayed in the series of serial images, or alternatively in a sequence of 10 static images shown in FIGS. 5A-5J, with a certain interval. As shown herein, it is preferable to show the series of status, from the incorrect insertion, that is, the current condition, to the correct insertion, and thereby enables the customers to understand the handlings regarding the card easily.

Shown in FIG. 1, diverse transactions may be applied with the card that has a plurality of magnetic strips and IC chips thereon depending on the inserted direction (proper or reverse direction). As an example of the embodiment, there are two magnetic strips on the card; the first one records the identification information for deposits and withdrawal transaction and the second one for loan transaction, respectively. Even if the customer has selected the deposits and withdrawal transaction on the operation unit 103, the insertion of the card in the opposite direction, which makes the card handler read out the identification information recorded in the second magnetic strip, results in disagreement between the selected transaction and the identification information read by the ATM. The inserted status is then judged as incorrect based on such information. With the series of serial images shown in FIGS. 5A through 5J, the customer can continue the transaction by changing the inserted direction in a right way for reinsertion.

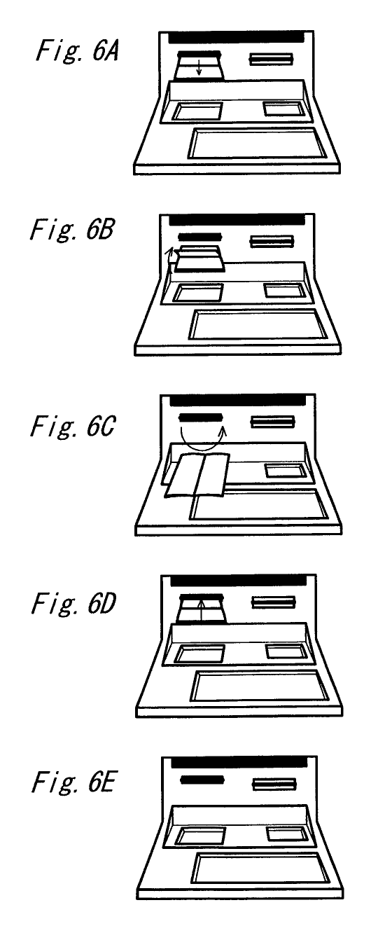

FIGS. 6A though 6E schematically illustrate the series of serial images. One example of the guidance for the insertion of the bankbook in the incorrect direction or with the incorrect page opened, such as the case of opening the page for fixed deposit instead of ordinary deposit by mistake, is shown. As shown in these figures, FIG. 6A shows a dispense image indicating the bankbook being dispensed, FIG. 6B a flip image indicating the bankbook being flipped, FIG. 6C a change image indicating the bankbook being changed its direction in the cross direction and FIG. 6D and FIG. 6E reinsertion images indicating a bankbook being reinserted into the slot.

According to the above-described ATM of this embodiment, displaying the guidance in the series of serial images, thus helps the customers to understand how to deal with the problems regarding the insertion of the card and the bankbook appropriately.

The series of serial images is not restricted to those of this embodiment, but may include a diversity of other displays. For example, it may be applicable to display the image to turn over the card in the side direction as well as in the cross direction shown in FIGS. 5A-5J. Alternatively, a change image indicating the bankbook, shown in FIG. 6C, may be omitted when the bankbook has been inserted with a wrong page opened in the correct direction. It may be preferable that the controller 120 stores that diversity range of image data therein so as to use those data depending on the inserted status of the card and the bankbook. The guidance in accordance with the present invention may include any one of operations instead of displaying various kinds of operations.

The series of serial images is not restricted to a sequential images in even speed or size, but may be displayed at a slow pace, that is, in slow motion, or zoomed at the important part, such as the change image in FIG. 5E, the flip image in FIG. 6B, the change image in FIG. 6C.

The series of serial images is not restricted to be started with the dispense image, but may be started with the change image in FIG. 5E or the flip image in FIG. 6B. Starting with the mid flow of a sequence of images allows required time for the guidance to be short, however, it may be preferable to include at least part of the scenes before the correct status is displayed in the guidance with a view to understanding of the customers.

In this embodiment, only the series of serial images is applied for the guidance, however, it may also be applicable to employ together with a sequence of static images. One possible application is to use those images corresponding to the operation for the guidance, for example, employing a sequence of static images for comparatively easy handlings and the series of serial images for harder handlings to be understood. Alternatively, it may also be applicable to display the guidance using only a sequence of static images for a certain period, and then display that together with the series of serial images, so as to reduce the load for the display by controlling frequency of use of the series of serial images.

According to the embodiment of this invention, ATM is preferably configured as ATM installed in credit institutions, however, another embodiment may also be applicable as a network system with a host computer and client computers.

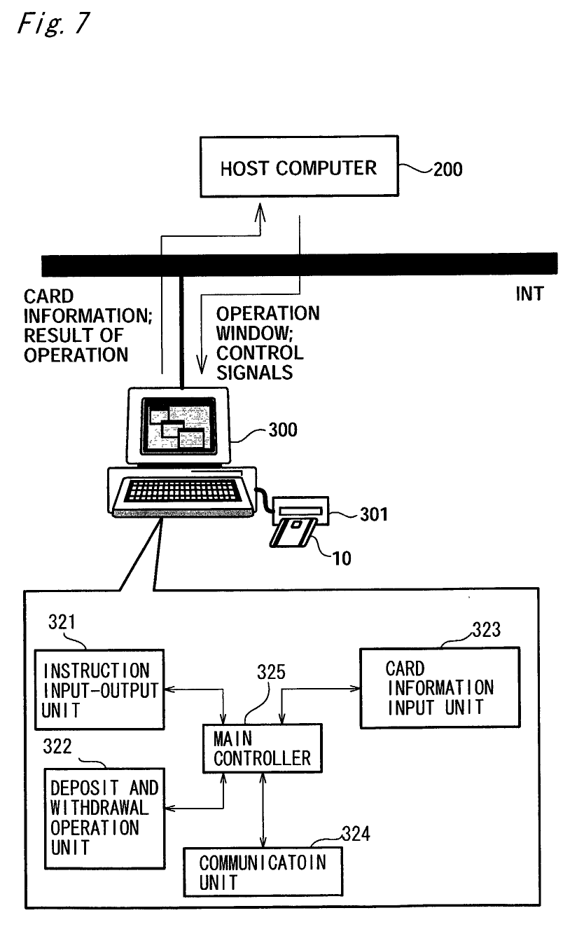

FIG. 7 schematically illustrates the structure of an ATM 300 in a modification of the present invention. The ATM 300 is configured as a client computer that is connected to an internet INT, and performs transactions by exchanging information via the internet with a host computer 200 that is managed by credit institutions. The ATM 300 may be implemented with an installation of an agent software in a personal computer. A card reader 301 is connected to the client computer. The card reader 301 can read out the information recorded in magnetic strips and IC chips on the card 10. A bankbook operation mechanism may preferably be connected.

A browser for viewing web pages, which are actualized by computer languages like HTML, is installed on the client computer, and the ATM 300 inputs and outputs information via web pages provided by the host computer. There are various pieces of information that is transmitted from the client computer to the host computer, such as the information read from the card 10 and the results of inquisition for transactions regarding the accounts and the money amounts. The information from the host computer to the client computer includes the operation windows that are actualized by Web pages, and the control signals for controlling the card reader 301.

The ATM 300 includes functional blocks of an instruction input-output unit 321, a deposit and withdrawal operation unit 322, a card information input unit 323, a communication unit 324 and a main controller 325 that are implemented as software, similar to FIG. 2. A bankbook information input-output unit is not illustrated herein as a bankbook operation mechanism is not applied in the ATM 300. Each functional block functions similar to the embodiment (FIG. 2).

The instruction input-output unit 321 presents, for example, the operation windows on the client computer in the form of Web page, and inputs the result of the operations with a mouse click. The instruction input-output unit 321 also displays the guidance for reinsertion when the card 10 has been inserted incorrectly (FIG. 4 -FIG. 6E). The image data for the guidance may be stored in the client computer together with software that achieves the functional blocks as shown in FIG. 7, or may be downloaded accordingly.

The above embodiments are to be considered in all aspects as illustrative and not restrictive. There may be many modifications, changes, and alterations without departing from the scope or spirit of the main characteristics of the present invention. For example, a series of control processes discussed above may be attained by the hardware construction, instead of the software configuration.

The ATM in accordance with the present invention enables customers to understand the handlings as to how to change the direction of the card or the bankbook, and how to flip the page of the bankbook easily by use of guidance with the series of serial images.

What is claimed is:

1. An automated transaction machine comprising:
an insert slot that accepts a card or a bankbook used for a transaction;
a judgment module that judges whether or not the card or the bankbook has been inserted in the insert slot in a correct status for the transaction; and
a guidance module that directs the correct status with a series of serial images when it is judged as an incorrect status.

2. The automated transaction machine in accordance with claim 1, wherein the series of serial images includes sequential images from the incorrect status to the correct status of the card or the bankbook.

3. The automated transaction machine in accordance with claim 1, wherein the series of serial images includes guidance to change an inserted direction of the card or the bankbook.

4. The automated transaction machine in accordance with claim 1, wherein the guidance module includes a guidance frame that displays a guide sentence explaining a customer's handling, and displays simultaneously both the series of serial images and the guide sentence.

5. The automated transaction machine in accordance with claim 1, wherein the judgment module executes the judging based on the transaction that is selected by a customer.

6. The automated transaction machine in accordance with claim 1, wherein the series of serial images includes:
a dispense image indicating the card being dispensed;
a change image indicating the card being changed its direction; and
a reinsertion image indicating the card being reinserted into the insert slot.

7. The automated transaction machine in accordance with claim 1, wherein the series of serial images includes:
a dispense image indicating a bankbook being dispensed;
a flip image indicating a bankbook being flipped;
a change image indicating a bankbook being changed its direction; and
a reinsertion image indicating a bankbook being reinserted into the insert slot.

8. An automated transaction machine that automatically performs a transaction selected by a customer, comprising:
a media handler that reads out information recorded in any one of a plurality of magnetic strips that are printed on a media;
an operation unit that accepts an operation performed by the customer;
a controller that judges whether or not the media is inserted in a correct status based on the information read by the media handler and transaction information accepted by the operation unit, and displays how to insert the media correctly with a series of serial images composed by a plurality of static images when the media insertion is judged as incorrect.

9. The automated transaction machine in accordance with claim 8, the media handler comprising:
an IC reader that reads out information recorded in an IC chip that is attached to the media,
wherein the controller detects the media insertion and displays the series of serial images onto the operation unit when the IC reader fails to read out the information recorded in the IC chip.

10. The automated transaction machine in accordance with claim 8, wherein the series of serial images includes sequential images from a dispense image indicating the media being dispensed to a reinsertion image indicating the media being reinserted.

11. An automated transaction machine in accordance with claim 8, wherein the operation unit includes a guidance frame to display a guide sentence explaining that the insertion is incorrect, and
the controller displays both the guide sentence and the series of serial images simultaneously.

12. An automated transaction machine in accordance with claim 8, wherein the media includes a card,
the media handler includes a card handler that handles the card, and
the controller displays the series of serial images that includes a dispense image indicating the card being dispensed, a change image indicating the card being changed its direction and a reinsertion image indicating the card being reinserted when the card insertion is judged as incorrect.

13. An automated transaction machine in accordance with claim 8, wherein the media includes a bankbook,
the media handler includes a bankbook handler that handles the bankbook, and
the controller displays the series of serial images that includes a dispense image indicating the bankbook being dispensed, a flip image indicating the bankbook being flipped, a change image indicating the bankbook being changed its direction and a reinsertion image indicating the bankbook being reinserted when the bankbook insertion is judged as incorrect.

14. A guidance method that directs an operation for the requested transaction in an automated transaction machine, the guidance method comprising the steps of:
judging whether or not a card or a bankbook is inserted in a insert slot of the automated transaction machine in a correct status for a transaction; and
directing a correct status for the card or the bankbook to be inserted with a series of serial images when it has been judged as an incorrect status.

15. A guidance method in accordance with claim 14, wherein the judging is executed based on the transaction that is selected by a customer.
